(19) United States
(12) Patent Application Publication
(10) Pub. No.: US 2010/0088234 A1
(43) Pub. Date: Apr. 8, 2010

(54) UNIFIED ANALYTICS ACROSS A DISTRIBUTED COMPUTING SERVICES INFRASTRUCTURE

(75) Inventors: George M. Moore, Bellevue, WA (US); Federico Raggi, Sammamish, WA (US); Yuan Yuan Yu, Bellevue, WA (US)

Correspondence Address: MICROSOFT CORPORATION, ONE MICROSOFT WAY, REDMOND, WA, 98052, US

(73) Assignee: MICROSOFT CORPORATION, Redmond, WA (US)

(21) Appl. No.: 12/245,585

(22) Filed: Oct. 3, 2008

(51) Int. Cl. G06Q 10/00; G06Q 30/00; H04L 9/00

(52) U.S. Cl. 705/52; 705/10; 705/14.49

(57) ABSTRACT

Methods and systems for providing unified analytics across a distributed computing services infrastructure are disclosed. Embodiments include providing an application identifier for an application created by a developer and, during an execution of the application, collecting and storing analytic data with an association with the application identifier and an authenticated developer identifier. Other embodiments may include collecting and storing analytic data with the association further including an authenticated user identifier and/or a device identifier for a device of a user-defined group or mesh. Access mechanisms, report generation, and billing based on the analytic data and associated application identifier are also disclosed. The disclosed methods and systems allow for unified reporting and correlation of analytic data across multiple services of a distributed computing services infrastructure.

### BACKGROUND

Detailed audience analytics for websites and other applications are essential to allow advertisers to efficiently reach targeted audience segments. A highly targeted application can drive higher advertising rates, as advertisers are willing to pay a premium to reach targeted niche audiences. Currently available audience analytics, however, capture only rudimentary audience information that is temporal, inconsistent across different applications, and may vary in quality, detail, and content. Thus, available audience analytics limit the revenue-generating potential for a developer or owner of the application.

In addition to the advertising realm, current available analytics also limit general corporate or enterprise efficiencies. Available analytics are largely limited to being collected from a specific service of a distributed computing services infrastructure, and therefore only provide a partial picture. For example, a website built to run on an enterprise service of the infrastructure may provide information pertaining to a visitor's interaction with the site. The website application, though, generally is not able to collect analytics from a “lower” level of services, such as from a storage service or an operating system service. Thus, utility analytics such as indications of the amount of CPU and/or memory used by the visitor's access of the website typically cannot be collected from the website program or application level, and vice versa.

Additionally, available analytics are typically difficult, if not impossible, to integrate and correlate across multiple services of a distributed computing services infrastructure, primarily due to the piecemeal nature of available computing infrastructures. For example, a developer may design his/her application to execute on an infrastructure where the database management system, the operating system, the host service of a website, and the actual servers themselves are each provided by different vendors. Collecting unified, correlated analytics for the application across multiple services and/or layers from different vendors may require customized routines. When a vendor changes, any customized analytics routines must be modified. Collecting unified analytics across multiple services and/or layers of the computing infrastructure quickly becomes expensive and intractable to develop and maintain.

### SUMMARY

This Summary is provided to introduce a selection of concepts in a simplified form that are further described below in the Detailed Description. This Summary is not intended to identify key features or essential features of the claimed subject matter, nor is it intended to be used to limit the scope of the claimed subject matter.

Embodiments of a method of providing unified analytics are disclosed. The method may include provisioning an application identifier for an application created by an authenticated developer for execution on a distributed computing services infrastructure (DCSI) or DCSI service. The application identifier preferably (but not necessarily) may be provisioned or assigned by the developer. During an execution of the application, analytic data points may be collected from each service of the DCSI that supports at least a portion of the execution. Collected analytic data may be stored in conjunction with an association with the application identifier, or may be stored further in conjunction with other associations, such as an association with a developer identifier, user identifier and/or a device identifier.

An access mechanism may be provided to allow access the stored analytic data via the application identifier and an authenticated developer identifier. Unified analytic reports may be generated for the application based on analytic data points collected from different services of the DCSI that supported at least a portion of the execution of the application. Billing the developer or other responsible billable party may be based on the application identifier.

Embodiments of a system for providing unified analytics across a distributed computing services infrastructure (DCSI) are disclosed. The system may include a distributed computing services infrastructure, an application, an application identifier, an analytics collector, and an analytics storage entity. Services of the DCSI may be realized across a plurality of computing devices of the DCSI. A developer may have a service agreement with one or more services of the DCSI, or with the entire DCSI. A DCSI may be, for example, a cloud computing infrastructure.

The application may be developed for execution on the DCSI or on one or more services of the DCSI. The developer of the application may be authenticated by the DCSI or by a DCSI service, and may have an authenticated developer identifier.

The application identifier may be provisioned by the developer, the DCSI itself, or a combination of the two. A separate application identifier may be assigned or provisioned for each version of an application or for different runtime configurations of the application.

The analytics collector may collect analytic data from each service that supports at least a portion of the execution of the application during an execution of the application. The analytics collector may associate the application identifier with each collected data point, and the data point and the association may be stored in the analytic storage entity. An authenticated user identifier and/or a device identifier may be also stored in conjunction with a collected analytic data point.

The system may also include an access mechanism for accessing stored analytic data points. The access mechanism may require an authenticated developer identifier and an application identifier before access is allowed to analytic data points for an application. The system may also include a report generator for producing unified analytic reports. A unified analytic report for an application may be based upon collected analytic data points from different services of the DCSI. The system may also include a billing entity for billing customers of the DCSI or DCSI service(s) based on an application identifier.

### DRAWINGS

FIG. 1 illustrates a block diagram of a general purpose computing device;

FIG. 2A depicts an exemplary embodiment of a system for providing unified analytics;

FIG. 2B shows an embodiment of possible users of an application that executes as part of the system of FIG. 2A;

FIG. 3 illustrates an exemplary embodiment of a method for providing unified analytics; and

FIG. 4 illustrates one embodiment of an access mechanism that may be used to access analytic data points for use in unified analytic reporting.

### DETAILED DESCRIPTION

Although the following text sets forth a detailed description of numerous different embodiments, it should be understood that the legal scope of the description is defined by the words of the claims set forth at the end of this patent. The detailed description is to be construed as exemplary only and does not describe every possible embodiment since describing every possible embodiment would be impractical, if not impossible. Numerous alternative embodiments could be implemented, using either current technology or technology developed after the filing date of this patent, which would still fall within the scope of the claims.

It should also be understood that, unless a term is expressly defined in this patent using the sentence “As used herein, the term ‘______’ is hereby defined to mean . . . ” or a similar sentence, there is no intent to limit the meaning of that term, either expressly or by implication, beyond its plain or ordinary meaning, and such term should not be interpreted to be limited in scope based on any statement made in any section of this patent (other than the language of the claims). To the extent that any term recited in the claims at the end of this patent is referred to in this patent in a manner consistent with a single meaning, that is done for sake of clarity only so as to not confuse the reader, and it is not intended that such claim term by limited, by implication or otherwise, to that single meaning. Finally, unless a claim element is defined by reciting the word “means” and a function without the recital of any structure, it is not intended that the scope of any claim element be interpreted based on the application of 35 U.S.C. § 112, sixth paragraph.

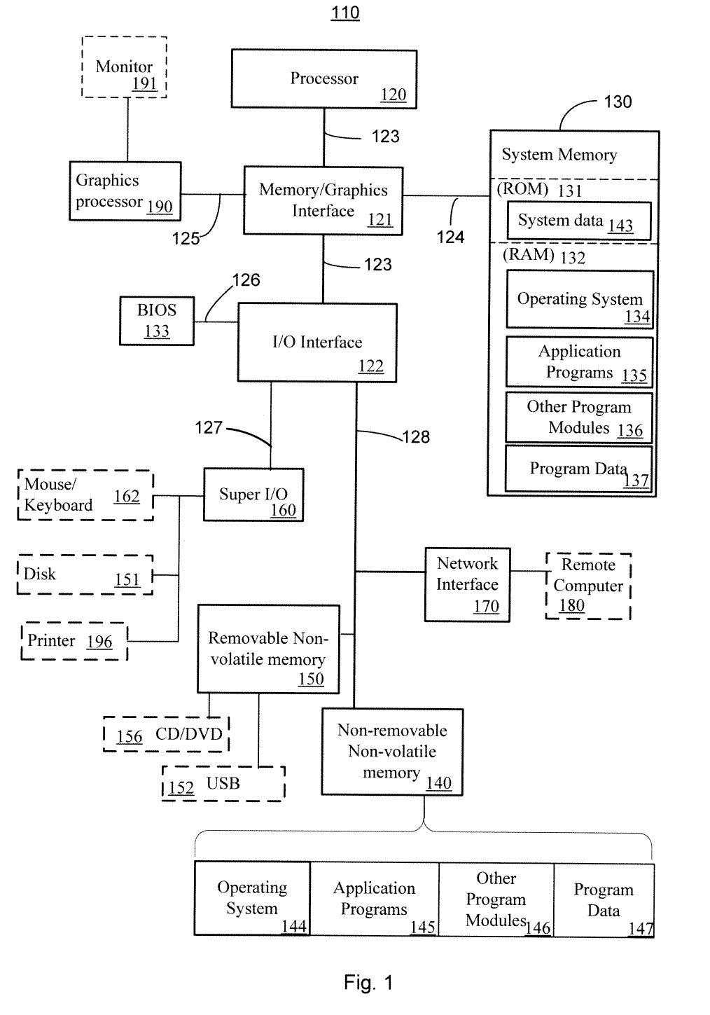

With reference to FIG. 1, an exemplary system for implementing the claimed method and apparatus includes a general purpose computing device in the form of a computer 110. Components shown in dashed outline are not technically part of the computer 110, but are used to illustrate the exemplary embodiment of FIG. 1. Components of computer 110 may include, but are not limited to, a processor 120, a system memory 130, a memory/graphics interface 121, also known as a Northbridge chip, and an I/O interface 122, also known as a Southbridge chip. The system memory 130 and a graphics processor 190 may be coupled to the memory/graphics interface 121. A monitor 191 or other graphic output device may be coupled to the graphics processor 190.

A series of system busses may couple various system components including a high speed system bus 123 between the processor 120, the memory/graphics interface 121 and the I/O interface 122, a front-side bus 124 between the memory/graphics interface 121 and the system memory 130, and an advanced graphics processing (AGP) bus 125 between the memory/graphics interface 121 and the graphics processor 190. The system bus 123 may be any of several types of bus structures including, by way of example, and not limitation, such architectures include Industry Standard Architecture (ISA) bus, Micro Channel Architecture (MCA) bus and Enhanced ISA (EISA) bus. As system architectures evolve, other bus architectures and chip sets may be used but often generally follow this pattern. For example, companies such as Intel and AMD support the Intel Hub Architecture (IHA) and the Hypertransport architecture, respectively.

The computer 110 typically includes a variety of computer readable media. Computer readable media can be any available media that can be accessed by computer 110 and includes both volatile and nonvolatile media, removable and non-removable media. By way of example, and not limitation, computer readable media may comprise computer storage media and communication media. Computer storage media includes both volatile and nonvolatile, removable and non-removable media implemented in any method or technology for storage of information such as computer readable instructions, data structures, program modules or other data. Computer storage media includes, but is not limited to, RAM, ROM, EEPROM, flash memory or other memory technology, CD-ROM, digital versatile disks (DVD) or other optical disk storage, magnetic cassettes, magnetic tape, magnetic disk storage or other magnetic storage devices, or any other medium which can be used to store the desired information and which can accessed by computer 110. Communication media typically embodies computer readable instructions, data structures, program modules or other data in a modulated data signal such as a carrier wave or other transport mechanism and includes any information delivery media. The term “modulated data signal” means a signal that has one or more of its characteristics set or changed in such a manner as to encode information in the signal. By way of example, and not limitation, communication media includes wired media such as a wired network or direct-wired connection, and wireless media such as acoustic, RF, infrared and other wireless media. Combinations of the any of the above should also be included within the scope of computer readable media.

The system memory 130 includes computer storage media in the form of volatile and/or nonvolatile memory such as read only memory (ROM) 131 and random access memory (RAM) 132. The system ROM 131 may contain permanent system data 143, such as identifying and manufacturing information. In some embodiments, a basic input/output system (BIOS) may also be stored in system ROM 131. RAM 132 typically contains data and/or program modules that are immediately accessible to and/or presently being operated on by processor 120. By way of example, and not limitation, FIG. 1 illustrates operating system 134, application programs 135, other program modules 136, and program data 137.

The I/O interface 122 may couple the system bus 123 with a number of other busses 126, 127 and 128 that couple a variety of internal and external devices to the computer 110. A serial peripheral interface (SPI) bus 126 may connect to a basic input/output system (BIOS) memory 133 containing the basic routines that help to transfer information between elements within computer 110, such as during start-up.

A super input/output chip 160 may be used to connect to a number of ‘legacy’ peripherals, such as read/writeable disk 151, keyboard/mouse 162, and printer 196, as examples. The super I/O chip 160 may be connected to the I/O interface 121 with a low pin count (LPC) bus, in some embodiments. The super I/O chip 160 is widely available in the commercial marketplace.

In one embodiment, bus 128 may be a Peripheral Component Interconnect (PCI) bus, or a variation thereof, may be used to connect higher speed peripherals to the I/O interface 122. A PCI bus may also be known as a Mezzanine bus. Variations of the PCI bus include the Peripheral Component Interconnect-Express (PCI-E) and the Peripheral Component Interconnect—Extended (PCI-X) busses, the former having a serial interface and the latter being a backward compatible parallel interface. In other embodiments, bus 128 may be an advanced technology attachment (ATA) bus, in the form of a serial ATA bus (SATA) or parallel ATA (PATA).

The computer 110 may also include other removable/non-removable, volatile/nonvolatile computer storage media. By way of example only, FIG. 1 illustrates a hard disk drive 140 that reads from or writes to non-removable, nonvolatile magnetic media. Removable media, such as a universal serial bus (USB) memory 152 or CD/DVD drive 156 may be connected to the PCI bus 128 directly or through an interface 150. Other removable/non-removable, volatile/nonvolatile computer storage media that can be used in the exemplary operating environment include, but are not limited to, magnetic tape cassettes, flash memory cards, digital versatile disks, digital video tape, solid state RAM, solid state ROM, and the like.

The drives and their associated computer storage media discussed above and illustrated in FIG. 1, provide storage of computer readable instructions, data structures, program modules and other data for the computer 110. In FIG. 1, for example, hard disk drive 140 is illustrated as storing operating system 144, application programs 145, other program modules 146, and program data 147. Note that these components can either be the same as or different from operating system 134, application programs 135, other program modules 136, and program data 137. Operating system 144, application programs 145, other program modules 146, and program data 147 are given different numbers here to illustrate that, at a minimum, they are different copies. A user may enter commands and information into the computer 20 through input devices such as a mouse/keyboard 162 or other input device combination. Other input devices (not shown) may include a microphone, joystick, game pad, satellite dish, scanner, or the like. These and other input devices are often connected to the processing unit 120 through one of the I/O interface busses, such as the SPI 126, the LPC 127, or the PCI 128, but other busses may be used. In some embodiments, other devices may be coupled to parallel ports, infrared interfaces, game ports, and the like (not depicted), via the super I/O chip 160.

The computer 110 may operate in a networked environment using logical connections to one or more remote computers, such as a remote computer 180 via a network interface controller (NIC) 170. The remote computer 180 may be a personal computer, a server, a router, a network PC, a peer device or other common network node, and typically includes many or all of the elements described above relative to the computer 110. The logical connection between the NIC 170 and the remote computer 180 depicted in FIG. 1 may include a local area network (LAN), a wide area network (WAN), or both, but may also include other networks. Networks may be wireless, wired, or a combination of the two. Such networking environments are commonplace in offices, enterprise-wide computer networks, intranets, and the Internet.

Computing device 110 may encompass many different computing device configurations. For example, computing device 110 may realized in hand-held devices, mobile phones, multi-processor systems, microprocessor-based or programmable consumer electronics, network PCs, minicomputers, mainframe computers, portable computing or communication devices, and or other computing device capable of both visual display and direct or indirect communication with another computing device.

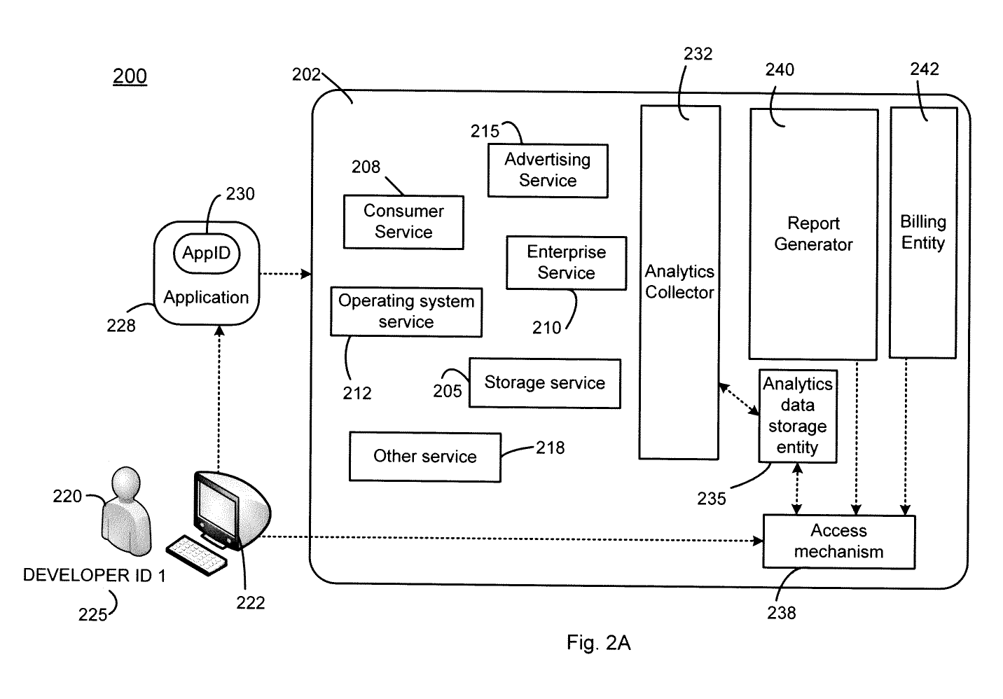

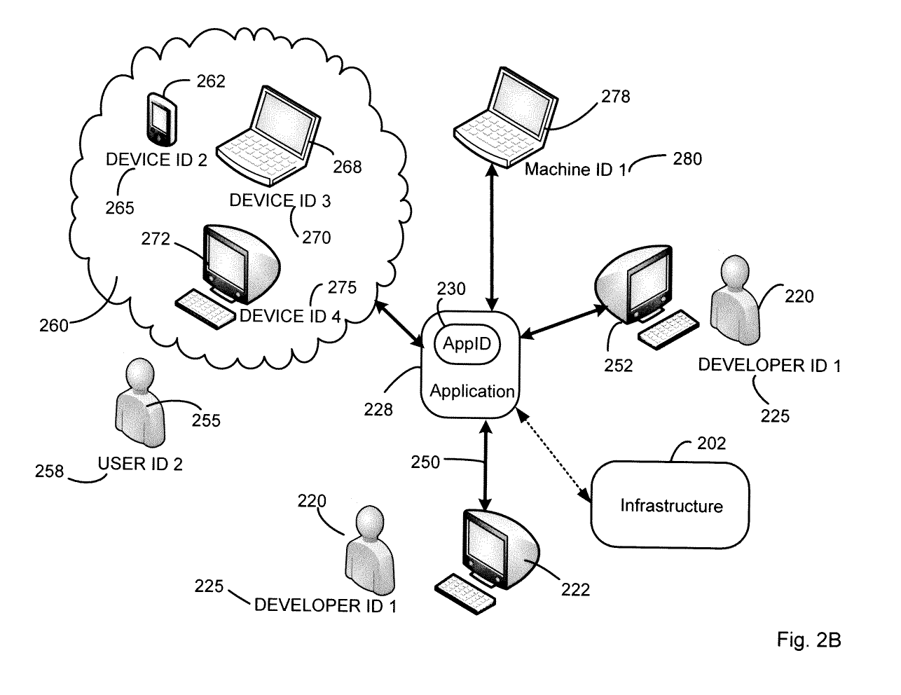

FIG. 2A depicts an exemplary embodiment of a system 200 for providing unified analytics. System 200 may include a distributed computing services infrastructure 202. The distributed computing services infrastructure (DCSI) 202 may be, for example, a cloud computing services infrastructure. Distributed computing services system 202 may be publicly accessible, or it may be located partially or entirely within a firewall, such as within a personal firewall or that of a company, organization or other enterprise. The distributed computing services infrastructure 202 may provide a plurality of services including a storage service 205, a consumer service 208, an enterprise service 210, an operating system (utility computing) service 212, an advertising service 215, and other services 218. Customers of the DCSI 202 may selectively enter into service agreements for one or more services offered by the DCSI 202. These services (205, 208, 210, 212, 215, 218) may be each realized by distributing computer-executable instructions, data structures, program modules and/or data related across one or more computing devices of the DCSI 202, but generally, a user or a customer of the DCSI 202 may have minimal knowledge of how portions of the services are actually distributed. The computing devices employed by DCSI 202 may be realized, for example, by embodiments of computing device 110 of FIG. 1.

Although five services (205, 208, 210, 212, 215) are depicted by FIG. 2A, DCSI 202 is not limited to the illustrated five services (205, 208, 210, 212, 215). One or more other services 218 may be included in distributed computing services infrastructure 202. In some embodiments of system 200, only one service may be included in DCSI 202. In some embodiments, several services may be included in DCSI 202, e.g., a storage service 205 and one of a consumer service 208 or an enterprise service 210. In some embodiments, more than five services may be included that may include a portion or all of the depicted services (205, 208, 210, 212, 215) and/or other services 218. In some embodiments, services may be combined, for instance, an operating system service 212 and a storage service 205 may be combined and appear as a single service offering to a user or customer. Other combinations and quantities of offered services may be possible.

Turning now to a discussion of each of the services depicted in FIG. 2A, a storage service 205 may provide computing storage to a user or customer. Examples of storage services may include SQL server database storage, basic storage, and DCSI-wide storage. Storage services 205 may typically include features such as automatic backup, error correction, failure mitigation, access security, scalability, and the like.

A consumer service 208 may be a service directed at an individual consumer or user. Consumer services 208 may generally be used to support business-to-consumer applications. Consumer services 208 may include features such as email accounts, instant messaging, social networking, blogs, photo albums, calendars, lists, news, personal computing storage, and the like. A consumer service 208 may allow an individual developer to create applications that execute on the consumer service 208, such as a personal website, blog or other such applications.

An enterprise service 210 may be a computing service directed at companies, organizations, and other enterprises. Enterprise services 210 may generally be used to support business-to-business applications. Enterprise services 210 may be used, for example, by ISVs (Independent Service Vendors), VARs (Value-Added Resellers), businesses, lines-of-business, institutions, corporations, and other such enterprises. Features provided by enterprise services may include, for example, workflow services, enterprise connectivity, chain and/or customer management, and other such enterprise-related services. An enterprise service 210 may allow a developer or customer to create websites and other business applications.

An operating system service 212 may be a computing service that provides operating system and utility platform services. An operating system service 212 typically (but not necessarily) may run at a “lower” level than a consumer service 208 or enterprise service 210, and may generally (but not necessarily) run at a “higher” level than a storage service 205. An operating system service 212 may communicate with servers and may provide lower level computing functions such as interfaces to memory and CPU, read/writes, and other such utilities.

An advertising service 215 may provide a platform for advertising via applications developed for consumer services 208 and/or enterprise services 210, such as websites, newsfeeds, on-line shopping, and the like. An advertising service 215 may typically (but not necessarily) run at a “higher” level than consumer services 208 or enterprise services 210. Advertising services 215 may provide functionality such as ad campaign definition, ad content and ad placement, as well as provide functionality to create and track analytics related to effectiveness, targeting, audiences, and other characteristics related to advertisements.

A user or customer of the distributed computing services infrastructure 202 may interface with DCSI 202 via one or more available services (205, 208, 210, 212, 215, 218). A user may have a service agreements with all services (205, 208, 210, 212, 215, 218) provided by the distributed computing services infrastructure 202, with a subset of services, or with a single service. For example, Individual Customer A may subscribe to a personal email service offered by the consumer service 208, and may also purchase additional storage 205 for archival purposes. In another example, Company B may purchase/use enterprise services 210 of the DCSI 202 to host a company website, manage human resources, and perform customer management, but perhaps may use different vendors' operating system, disk storage space, and advertising services. In yet another example, Institution C may use a “top-to-bottom” solution from DCSI 202 and may procure storage services 205, operating system services 212, enterprise services 210 and advertising services 215 to support their operations.

Reference 220 represents a user of the distributed computing services infrastructure 202. In the embodiment of system 200 depicted by FIG. 2A, the user 220 represents a developer 220 that may access DCSI 202 via a computing device 222. Computing device 222 may be, for example, an embodiment of computing device 110 of FIG. 1. Developer 220 may identify him/herself to DCSI 202 or a service therein via a developer identifier 225 (in this example, “DEVELOPER ID 1”). The developer identifier 225 may be authenticated by the DCSI 202 or by a service of DCSI 202. After authentication, developer 220 may be authorized to access the DCSI 202 or any services therein with which s/he has a service agreement. Developer 220 may access a service of the DCSI 202 and create an application 228 for execution on the service. For instance, developer 220 may create a website application to run on consumer service 208. Or, developer 220 may create, for example, a payroll application to execute on enterprise service 210, or an API to run on operating system service 212.

Developer-created application 228 may be provisioned with an application identifier 230. The application identifier 230 may be automatically provisioned by DCSI 202 or by the hosting service of application 228. Alternatively, the developer 220 may directly provision the application identifier 230, or some combination of automatic and manual provisioning may be used. DCSI 202 may retain the association of the developer identifier 225 and the application identifier 230. It should be understood that developer 220 may not be limited to a single physical person. For instance, developer 220 may represent a work team or group in a company that jointly creates application 228. Each member of the work group may have his/her own personal developer identifier, and the work group itself may have a work group developer identifier. The work group identifier and the personal developer identifiers may be correlated. For example, the personal developer identifiers may be derivable from the work group developer identifier, and/or the work group developer identifier may be derivable from each personal developer identifier. Or, in another embodiment, the relationship between work group developer identifier and personal developer identifiers may be stored in a database. The application identifier 230 may be associated with the work group identifier in DCSI 202, and any personal developer identifier corresponding to the work group identifier may have the same privileges as the work group identifier by virtue of their association.

In another example, the application identifier 230 may be associated with a company-level or organizational developer identifier. For example, an employee of Company D may develop an initial version of an application using his/her personal developer identifier, but then s/he may leave the company. Company D may retain legal ownership rights to the application, and therefore may replace the ex-employee's developer identifier with a company developer identifier to be associated with the application identifier 230.

Other examples of personal, work group, and organizational developer identifiers are possible. Flexibility, modification, creation, deletion, and hierarchy of derivable and associated developer identifiers may be possible in system 200.

The application 228 may execute on the distributed computing services infrastructure 202, such as when invoked by another user. In particular, the application 228 may execute on the service for which it was written, but may also incorporate other services with which the developer 220 has a service agreement during its execution. For example, if a website application was developed via consumer service 208, and the developer 220 has service agreements for utility platform services 212 and storage services 205, the website application may use both operating system services 212 and storage services 205 when another user invokes its execution by visiting the website.

During the execution of application 228, an analytics collector 232 may collect analytics data points for each service that is invoked during the execution. Although only one analytics collector 232 is illustrated in FIG. 2A, multiple analytics collectors 232 may be possible. For example, a different analytics collector may exist for each different service 205, 208, 210, 212, 215, 218 of the DCSI 202.

The analytics collector 232 may associate each collected data point with the application identifier 230, and may store the data point and the association with the application identifier 230 in an analytics data storage entity 235. The analytic data points that are collected may be specific to each service. For example, the operating system service 212 may collect data such as the number of reads or writes that occurred during the execution of the application 228, amount of CPU used by the execution of the application 228, amount of temporary memory used during the execution of the application 228, and the like. At an application level (e.g., consumer service 208 or enterprise service 210), analytics may be collected for categories of websites visited, the sequence of clicks that lead to a specific function or application being invoked, feature usage, etc. At an advertising service level 215, analytics may be collected such as number of impressions, time spent on a webpage, clicks on suggested marketing links, etc.

Of course, these examples are merely meant to give a flavor of what types of data may be collected and are not comprehensive. Other analytic data may be collected. The types of analytic data points that are collected for each type of computing service are extensive. System 200 does not attempt to limit the types of collected analytic data points, but merely provides an association between an analytic data point collected during the execution of an application 228 with the application's application identifier 230. Analytics data storage entity 235 may normalize data views across various services so that data may be queried and represented in a consistent manner.

In one embodiment, analytics collector 232 may make the application ID 230 available to each service, and thus each service may collect analytic data points and directly incorporate the application ID into the data point itself. In another embodiment, analytics collector 232 may use the standard available interface to each service, and in a separate step, associate the application ID 230 with each collected data point. Thus, each service would not be required to have knowledge of the application ID 230. In another embodiment, analytics collector 232 itself may be distributed amongst each service. For example, the consumer service 208 may have its own local analytics collector for collecting data points and associating them with an application ID 230, the storage service 205 may have its own local analytics collector, the advertising service 215 may have its own local analytics collector, and so on. In some embodiments, each feature within a service may have its own feature-level analytics collector for collecting data and associating it with the appropriate application ID 230. For example, in the storage service 205, a SQL server database feature may have its own analytics collector, and a DCSI-wide storage service feature may have its own analytics collector. Other embodiments of associating the application ID 230 with each collected data point may be possible, and combinations of embodiments may also be possible.

The collected analytic data may be stored in analytics data storage entity 235. In some embodiments, the association of the application ID 230 may be directly embedded in the data point itself. In other embodiments, the association between each analytic data point and the application identifier 230 may be separate from the data point itself, but may be stored together. Alternatively, some other mechanism to determine the application identifier 230 for a stored analytic data point may be possible, such as using a data or directory structure, a label, a flag, a handle, some other mechanism or combination of mechanisms.

In system 200, the wealth of collected analytic data may contain rich information with respect to identifying the user or source who actually initiated the execution of the application. FIG. 2B illustrates an embodiment of an exemplary set of users of application 228 from FIG. 2A that executes on DCSI 202 and has application identifier 230. Similar to FIG. 2A, developer 220 of application 228 is shown in FIG. 2B as having an authenticated developer identifier 225. In FIG. 2B, however, instead of illustrating the creation of application 228 by developer 220 using computing device 222, developer 220 is shown as executing application 228 via computing device 222, as represented by the thick double-headed arrow 250.

So, in an embodiment of system 200, when developer 220 executes application 228 on DCSI 202, each collected analytic data point may include an association with not only the application identifier 230 but also with developer identifier 225. As previously discussed, analytic data points may be collected for any service in DCSI 202 for which developer 220 has a service agreement and that supports the execution of application 228. Analytics collector 232 may coordinate and oversee the collection, and may associate the developer identifier 225 with the collected data point(s). The data points and the associations may be stored in analytics data storage 235.

Authenticated developer identifier 225 may correspond to a host of detailed user information (previously approved by developer 220 for use by DCSI 202 or a service thereof). This detailed user information may be associated with a specific analytic data point. No longer is an analytic data point associated with a mere IP address or bare bones user name, but instead it may be associated with a rich set of user information accessible via the authenticated developer identifier 225. Examples of this information may include birth date, gender, industry, occupation, job title, marital status, any children, one or more addresses country, zip code, and any other information collected by system 200 and stored with the permission of developer 220. The stored user information associated with authenticated developer identifier 225 may provide more significant detail, and thus may allow a customer of DCSI 202 or services thereof to gain greater audience intelligence regarding the users of his/her application 228.

If developer 220 uses a different device 252 to access DCSI 202, for example, a computer at a friend's house, at work or at a library, s/he may first sign on to DCSI 202 or to a service therein using his/her developer identifier 225. After authentication of the developer identifier 225, developer 220 may invoke application 228. Any collected analytics associated with this execution of application 228 may be automatically associated with user 220 based on his/her authenticated developer identity 225.

FIG. 2B also illustrates another possible scenario of analytic data granularity. User 255 may be an authenticated user of distributed computing services infrastructure 202 or of a service therein. User 255 may or may not be a developer, and may have an authenticated user identifier 258 (e.g., “USER ID 2”). Similar to DEVELOPER ID 1 (reference 225), USER ID 2 (reference 258) may also provide a link to a rich set of information for user 255. Also similar to DEVELOPER ID 1 (reference 225), any stored personal information for user 255 used by system 200 may be stored only with the permission of user 255.

User 255 may have defined a mesh 260 or group of computing devices. In the illustration of FIG. 2B, mesh 260 is shown as having three group members: computing device 262 having DEVICE ID 2 (reference 265), computing device 268 having DEVICE ID 3 (reference 270), and computing device 272 having DEVICE ID 4 (reference 275). Computing devices 262, 268 and 272 of mesh or group 260 may each take the form, for instance, of any embodiment of computing device 110 illustrated in FIG. 1. Although three specific devices are shown by FIG. 2B as being defined as members of mesh 260, the quantity, types, and exact identifiers of the illustrated computing devices are exemplary only. In fact, any number of computing devices having any type of device identifiers may be defined by user 255 as being a part of mesh 260. The association of devices 262, 268, 272 to mesh 260 (and the resulting device identifiers 265, 270, 275) are typically made per the instruction or direction of the mesh or group owner, in this example, per the request of user 255.

Mesh 260 illustrates how not only may the user identifier 258 be associated with the application ID 230 during the execution of application 228, but the device identifier 265, 270, or 275 may also be associated with application ID 230 as well. For example, user 255 may define a mesh 260 as including his/her office computer 268, home computer 272, and PDA 262. User 255 may tend to visit different websites while using the office computer 268 compared to while using the home computer 272. The office computing device 268 and the home computing device 275 may have different device identifiers (270 and 275, respectively), and thus any collected analytic data point may be associated with the proper device identifier and may be able to reflect this distinction. Similarly, the time that user 255 spends on a particular website while browsing with his/her PDA 262 may be significantly different than the time spent browsing the same website on his/her home computer 272. These differences may be able to be accurately recorded by associating the appropriate specific device identifier (265 or 275) with USER ID 2 (reference 258) and application ID 230.

If a different user (not shown) other than user 255 executes application 228 on a device in mesh 260, any analytic data points gathered may be associated with the authenticated user ID of the different user and the device ID of the employed device. An example of this scenario may be if user 255 is a parent that defines a group 260 to include several home computers, a digital video recorder, and several PDAs or wireless devices. Each device may be defined to have its own device identifier within the mesh 260, and each member of the household may have his/her own user identifier. System 200 may be able to differentiate between analytics collected while Mom was running application 228 on the kitchen computer versus analytics collected while Junior was running application 228 on the kitchen computer versus analytics collected while Dad was running application 228 on his PDA, all based on different authenticated user identifiers and device identifiers.

Therefore, by associating both the user identifier 255 and the device identifier (265, 270 or 275) with the application ID 230, system 200 may be able to provide a finer granularity of user profile distinction attributable to user 255 executing application 230 on a device of a mesh 260.

Finally, if application 230 is executed by an unauthenticated user on a computing device 278, system 200 may associate a machine identifier 280 (e.g., “MACHINE ID 1”) with the application ID 230 for analytics purposes. Machine identifier 280 may be, for example, an IP address, MAC address, or other type of machine identifier. In this example, the richness of the user profile is unavailable as the user has not authenticated with the distributed computing services infrastructure 202, however, correlation of any collected analytic data points across various services in the DCSI 202 may still be possible and obtained.

The associations of application identifier 230 with a developer or user identifier, device identifier, and/or machine identifier provide a powerful way to correlate analytics data across services. Analytics that were previously disjoint and independently viewed may be correlated at higher levels using system 200. Accordingly, system 200 may provide a more comprehensive view on analytic data to customers.

A couple of examples easily illustrate these advantages of system 200. Consider the example of a diaper manufacturing company that has service agreements with DCSI 202 for enterprise services, advertising services, operating system services, and storage services. The diaper manufacturing company develops a website application that is hosted on the enterprise service, is supported by the operating system and storage services, and includes advertising campaigns from the advertising service. Based on the unified data analytics from system 200, the diaper manufacturing company is able to detect a non-intuitive significant increase in the number of hits to a news article on their website regarding Halloween candy safety beginning in the month of September. Using the unified analytics, the diaper manufacturing company is able to determine the magnitude of the seasonal increase in website traffic, and then determine the number of additional servers and memory required in September to support the seasonal traffic bubble. It is also able to create cross-marketing opportunities on its website with candy manufacturers and/or companies that sell Halloween costumes for children under the ages of six in anticipation of the seasonal traffic bubble.

Consider another example of a university that provides an authenticated user identifier for each of its students to access a distributed computing services infrastructure used to support the university's enterprises. The university's students are required to log on to the DCSI to access enterprise services such as university email accounts, courses, libraries, and other such information. The students, however, as students will do, spend some portion of their time surfing the Internet for personal reasons. With system 200, the university is enabled to collect (with their students' permission) detailed information on what types of websites are surfed by which user identifiers on which particular computing devices. Such an audience is by definition highly targeted. The university may then use this highly targeted audience data to attract advertisers for ad placement on sites most likely visited by its students. Based on the highly targeted nature of the audience, the university may be able to drive higher eCPMs from advertisers. In fact, the university may be able to recover some of its IT and other costs using based on the higher eCPMs.

These unified analytics may allow a developer or customer of the distributed computing services infrastructure 202 to obtain greater comprehensive detail, insight and intelligence into his/her applications. Seasonality predictions, even those which are non-intuitive, may be discovered and, more importantly, quantitatively verified using concrete data points. Obtained demographic information may be richer given that many users of applications are authenticated users of the DCSI for which detailed, user-approved profiles exist. Causality correlations may be easily created, especially between different services and/or levels of the DCSI. This rich, comprehensive detailed information may lead to more precise content targeting of audiences, which in turn may attract higher eCPM from advertisers, which in turn may lead greater return on investment for customers of the DCSI or services therein.

Turning attention back to FIG. 2A, in order to leverage the richness of the collected data, an access mechanism 238 may be provided by the distributed computing services infrastructure 202 to enable access to analytic data points associated with his/her application 228, such as those stored in analytics data storage 235 and other storage locations. The access mechanism may include authentication so that analytic data is protected. For example, a developer may be required to provide an authenticated developer ID (225) and an application ID (230) before access to collected analytic data is allowed. Other protection mechanisms may also be possible.

Any form of database access may be used in accordance with access mechanism 238. For example, data points may be retrieved via standard database queries, standard or customized APIs, a handle based on application ID 230 and/or developer ID 225, and/or any other known access mechanism. Access mechanism 238 may be used manually by a developer 220 or automatically by a routine or program.

System 200 may include a report generator 240 enabled to generate a unified analytic report based on application ID 230. A unified analytics report may include a report based on more than one collected analytic data point for the application, where at least two of the collected data points were collected for different services. Correlation of data between the different services may be generated for inclusion on a unified analytics report. The generated unified analytics report may be displayed, stored, and/or sent to another computing system or entity.

A report generator 240 may automatically generate a unified analytics report, such as a report that is scheduled to automatically generate on a periodic basis. In this embodiment, the report generator 240 may use access mechanism 238 to obtain the information needed for the report from the analytics data storage 235.

In another embodiment, the report generator 240 may generate a unified analytics report per the request of a developer. In this embodiment, the report generator 240 may also use access mechanism 238 to obtain the information needed for the report from analytics data storage 235.

In another embodiment, the report generator 240 may provide a display format and/or tools for generating a format or presentation layout of a unified analytics report, but the actual analytic data on which the report is based may be provided by the developer 220. The developer 220 may process the obtained data via access mechanism 238 and send it to the report generator 240 for producing the complete unified analytics report.

In another embodiment, the report generator 240 may not be used at all. A developer may manually use access mechanism 238 for obtaining desired data from the analytics data storage 235, and may manually create a unified analytics report. Other report generation embodiments in addition to those described in the present disclosure may also be possible.

System 200 may provide a billing entity 242 enabled to bill a developer or billable party based on the application identifier 230. For a billing model based on application identifier 230, the billing entity 242 may be able to determine, for an application 228, a breakdown of billable items from each service (or feature(s) thereof) that supported the application and resultant charges for each billable item. For example, for an application, the DCSI 202 may set up a business model where a set monthly fee is charged for hosting a website, but the charges for storage service and certain functions of the operating system service vary by usage. Each item (i.e., hosting, storage, OS functions) may be billed as a separated line item, and the cost or charge for each line item may be reflected on the bill. Charges may be of any type, including a set fee, per time unit, per service unit, per physical unit, combinations thereof, and other types of charging options.

The billing entity 242 may use access mechanism 238 to obtain desired data from analytics storage entity 235. The billing entity 242 may support other additional types of billing models selectable by the DCSI 202. The option to select a billing model based on application identifier 230 may be selectable.

Similar to the services (205, 208, 210, 212, 215, 218) provided by the distributed computing services infrastructure 202, other entities (232, 235, 238, 240, 242) of the DCSI 202 may also each be distributed across various computing entities of the DCSI 202. That is, computer-executable instructions, data structures, program modules, storage, etc. of each of the other entities (232, 235, 238, 240, 242) are not limited to one physical computing device, but may be located locally or remotely across various computing devices of the DCSI 202.

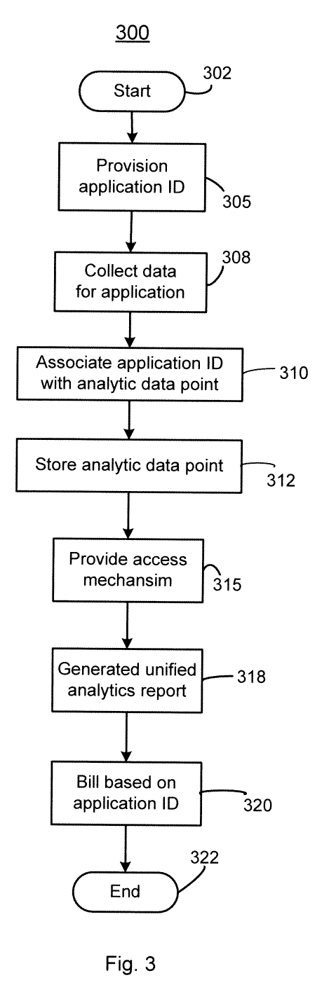

FIG. 3 illustrates an exemplary embodiment of a method 300 for providing unified analytics. Embodiments of method 300 may operate in accordance with embodiments of system 200 of FIGS. 2A and 2B, and also may operate in accordance with embodiments of the computing entity of FIG. 1.

At the start 302 of method 300, an application identifier for an application may be provisioned 305. The application may be executable on a distributed computing services infrastructure (DCSI) that provides a plurality of computing services, such as DCSI 202 of FIG. 2A. The execution of the application may require the support of one or more computing services from the DCSI 202. In an exemplary embodiment, the application may be created by an authenticated developer of the DCSI or by an authenticated developer of a service of the DCSI. The developer may have a developer identifier that is used for access to the DCSI and/or a service therein. In some embodiments, a password may also be required for authentication. The developer identifier may be authenticated by the DCSI or service before the developer is allowed access to any services of the DCSI, including being allowed to create an application.

After the application has been created by the developer, the DCSI and/or service of the DCSI may automatically provision 305 the application identifier for the application. In some embodiments, the developer may manually provision 305 the application identifier. Or, the application identifier may be provisioned 305 using some combination of automatic and manual provisioning. A developer may provision 305 a separate, distinct application identifier for each version and/or runtime configuration of an application. For example, the developer may with to distinguish between a test version, a beta version, an updated version, etc. of an application by using distinct application identifiers for each version. In another example, the developer may with to distinguish between a production and a test deployment of the application in different runtime configurations by using a distinct application identifier for each deployment/runtime configuration combination.

The application may be executed. During its execution, analytic data points may be collected 308 for each service that supports the execution of the application. Generally, but not necessarily, the services for which data points are collected may be services with which the developer has a service agreement. As previously discussed, a plethora of different types of analytic data may be collected 308 for each service.

Each collected data point may be associated with the application identifier 310. This association may be realized in any number of ways. For instance, in one embodiment, the services themselves may be ignorant of the application identifier, and another entity such as analytics collector 232 of FIG. 2A may perform the association for each collected data point. A global analytics collector may be available, or local analytics collectors for each service and/or for each feature within a service may be possible. In other embodiments, the application identifier may be made available to each service for use during collection. Other ways of association may also be possible.

In some embodiments, each collected data point, in addition to being associated with an application identifier 310, may also be associated with a user identifier and/or a device identifier. As previously discussed with respect to FIG. 2B, an authenticated user of the DCSI or service may execute the application, and his/her authenticated user's identifier may be associated with the application identifier. In cases where the user has defined one or more devices to be part of the user's group or mesh, a device identifier corresponding to a device in the group/mesh may also be associated with the application identifier and user identifier.

The collected data point and its association with the application identifier may be stored 312, for example, in an analytic data storage area such as data storage area 235 of FIG. 2A. The data point and the application identifier may be stored together, or some other mechanism such as a handle, a flag, a directory or data structure, etc. may be used to retain the association of the analytic data point with the application identifier.

An access mechanism may be provided 315 to allow the developer to access collected data for his/her application. The access mechanism may be protected so that the data points associated with a particular application are secure and cannot be accessed by nefarious parties. In one embodiment, the access mechanism protection may require both an authenticated developer identifier and the application identifier in order to gain access to the data. Other protection mechanisms may also be employed.

At step 318, a unified analytics report may be generated for the application. The unified analytics report may be based upon data points that were collected 308 for different services in the DCSI during the execution of the application. A comprehensive, correlated view may be provided by the unified analytics report using the data point obtained for the different services.

A unified analytics report may be manually generated 318 by the developer. For example, a developer may access a particular subset of the collected data for his/her application (315), analyze and process the data, and manually build a report for generation. In another embodiment, the developer may choose to send raw or processed data to a report generator associated with the DCSI, such as report generator 240 of FIG. 2A. Report generator may have a library of reports, actions, presentation formats, data functions, etc. used to process the data into a meaningful report. In other embodiments, a unified analytics report may be automatically generated 318 by the report generator, for example, on a periodic basis. In some embodiments, a developer may request that a specific report be generated at a specific time or based on a specific event. This request may be sent to the report generator to be realized. When needed, a report generator may access the collected data (block 315) to pull the information that it needs for a particular report. In some embodiments, a combination of manual and automatic report generation 318 may be possible. Note that step 318 is optional for method 300, and in some embodiments of method 300, step 318 may be omitted.

At step 320, billing, based on the application identifier, may be performed. Billing based on application identifier 320 may be one of several available selectable billing options. Billing by application identifier 320 may be realized by itemizing each service or portions thereof according to an amount utilized by the application. Charges for each line item may be reflected on the bill. The bill may be targeted for a responsible, billable party associated with the application, such as an individual developer, an organization that has legal ownership of the application, or a work group within the owning organization. Note that step 320 may also be optional in method 300, and in some embodiments of method 300, step 320 may be omitted.

Finally, at step 322, method 300 may end.

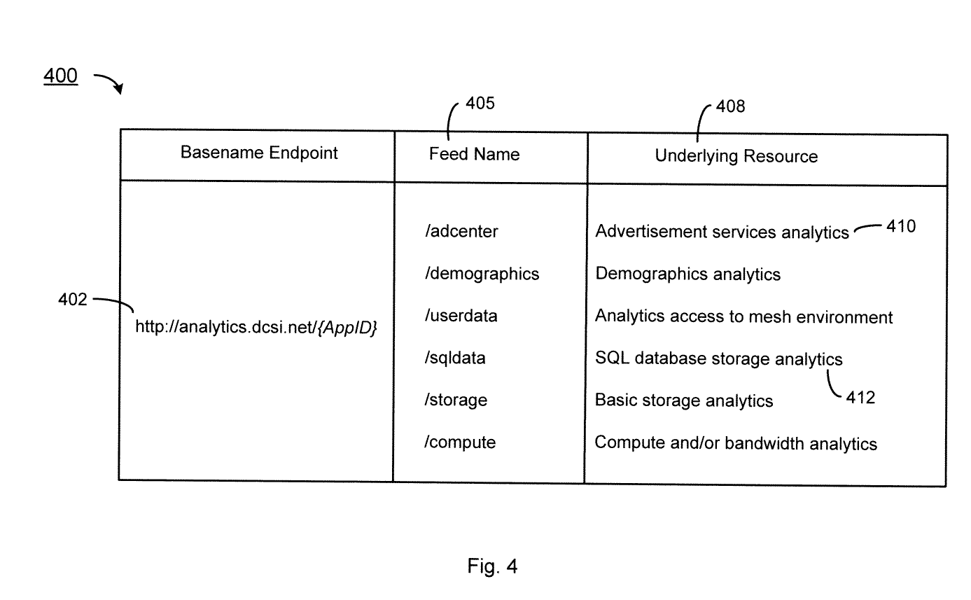

FIG. 4 illustrates an embodiment of an access mechanism 400 for accessing collected analytic data points and their associations with application identifiers. Access mechanism 400 may be an embodiment of access mechanism 238 of FIG. 2A, and may access, for example, analytic data storage 235. Access mechanism 400 may be used in conjunction with any embodiments of the methods and systems of this disclosure. In FIG. 4, the exact text names shown in access mechanism 400 are merely exemplary and not meant to be limiting; other text names are also possible.

A user or developer may be authenticated prior to using access mechanism 400. Access mechanism 400 may support a base name endpoint 402 that may provide pivots across a number of resources related to a specific application. In the embodiment illustrated in FIG. 4, base name endpoint 402 may be a handle to a specific application identifier (i.e., “{AppID}”) in a DNS format. In this example, the base name endpoint for an application with an application identifier of APP_ID_{—}1 may be a URL such as http://analytics.dcsi.net/APP_ID_{—}1.

Upon grabbing the handle to APP_ID_{—}1, a developer (or report generator or other authorized party using access mechanism 400) may then pivot across various feeds 405 relating to the specified application identifier to obtain corresponding analytics. For instance, in access mechanism 400, the URL http://analytics.dcsi.net/APP_ID_{—}1/adcenter may allow a developer to access collected analytic data for application identifier APP_ID_{—}1 from the advertising service. The underlying resource 408 of the distributed computing services infrastructure that supports the application at the advertising service level may be an advertising services application analytics resource 410 specific to the advertising service. In another example, http://analytics.dcsi.net/APP_ID_{—}1/sqldata may allow a developer to access collected analytic data for application identifier APP_ID_{—}1 from an SQL server data services analytics resource 412.

This embodiment illustrated by access mechanism 400 allows for various feeds 405 to be easily added and modified. Other base name endpoints may exist for an authenticated user identifier (within the confines of the authenticated user's consent, of course), a device identifier, or combinations of the identifier types. Each of the underlying feeds may have their own versions that may operate independently of other feeds.

Although the foregoing text sets forth a detailed description of numerous different embodiments, it should be understood that the scope of the patent is defined by the words of the claims set forth at the end of this patent. The detailed description is to be construed as exemplary only and does not describe every possible embodiment because describing every possible embodiment would be impractical, if not impossible. Numerous alternative embodiments could be implemented, using either current technology or technology developed after the filing date of this patent, which would still fall within the scope of the claims.

Thus, many modifications and variations may be made in the techniques and structures described and illustrated herein without departing from the spirit and scope of the present claims. Accordingly, it should be understood that the methods and apparatus described herein are illustrative only and are not limiting upon the scope of the claims.

What is claimed:

1. A method of providing unified analytics, comprising:
provisioning an application identifier for an application developed to execute on a distributed computing services infrastructure, the distributed computing services infrastructure including a storage service and at least one of a consumer service or an enterprise service;
collecting an analytic data point at each service corresponding to an execution of the application, the each service included in the distributed computing services infrastructure, the analytic data point corresponding to the execution of the application;
associating the collected analytic data point with the application identifier;
storing the collected analytic data point; and
providing an access mechanism, the access mechanism allowing access to the stored, collected analytic data point based on the application identifier and an authenticated developer identifier, wherein:
the authenticated developer identifier corresponds to at least one of: a developer of the application, an organization having legal ownership of the application, or a work group of the organization, and
the authenticated developer identifier is authenticated by at least one of the services supported by the distributed computing services infrastructure.

2. The method of claim 1, wherein the distributed computing services infrastructure further includes at least one of an advertising service or an operating system service.

3. The method of claim 1, wherein provisioning the application identifier for the application comprises provisioning an application identifier corresponding to a version of the application.

4. The method of claim 1, wherein provisioning the application identifier for the application developed to execute on the distributed computing services infrastructure comprises provisioning the application identifier for the application developed to execute on a cloud computing infrastructure.

5. The method of claim 1, wherein collecting the analytic data point comprises:
collecting the analytic data point for each service corresponding to an execution of the application by an authenticated user, and
associating the analytic data point, the application identifier, and an authenticated user identifier, wherein:
the authenticated user identifier corresponds to the authenticated user, and
the authenticated user identifier is authenticated by at least one service included in the distributed computing services infrastructure.

6. The method of claim 1, wherein collecting the analytic data point comprises:
collecting the analytic data point for each service corresponding to an execution of the application by an authenticated user on a device, and
associating the analytic data point, the application identifier, an authenticated user identifier, and a device identifier, wherein:
the authenticated user identifier corresponds to the authenticated user,
the authenticated user identifier is authenticated by at least one service included in the distributed computing services infrastructure,
the device identifier corresponds to the device, and
the device identifier is associated with the authenticated user identifier per an instruction of the authenticated user.

7. The method of claim 1, wherein provisioning the application identifier for the application developed to execute on the distributed computing services infrastructure comprises provisioning the application identifier for an application developed to execute in both a connected mode and a local mode.

8. The method of claim 1, wherein provisioning the application identifier comprises provisioning the application identifier based on input from the developer of the application.

9. The method of claim 1, further comprising generating a unified analytic report for the application based on more than one collected analytic data point, wherein at least two of the more than one collected analytic data point are each collected for a different service included in the distributed computing services infrastructure.

10. The method of claim 9, wherein generating the unified analytic report comprises generating a unified analytic report containing at least one of: a seasonality prediction, a resource need determination, a demographic prediction, or a causality correlation.

11. The method of claim 1, further comprising billing the developer of the application based on the application identifier.

12. A system for providing unified analytics, comprising:
a distributed computing services infrastructure having a plurality of services, including a storage service and at least one of an enterprise service or a consumer service;
an application associated with an authenticated developer identifier, the application enabled to run on the distributed computing services infrastructure, the authenticated developer identifier authenticated by at least one of the plurality of services of the distributed computing services infrastructure;
an application identifier corresponding to the application, the application identifier available to each of the plurality of services of the distributed computing services infrastructure;
an analytics collector enabled to:
collect an analytic data point for each service of the distributed computing services infrastructure corresponding to an execution of the application, the analytic data point corresponding to the execution of the application, and
associate the application identifier with the analytic data point; and
an analytics data storage entity enabled to:
store the analytic data point and the association of the analytic data point with the application identifier, and
normalize the analytic data point with other collected analytic data points.

13. The system of claim 12, further comprising an access mechanism for allowing access to the analytic data point, wherein the access mechanism is based on the application identifier and the authenticated developer identifier.

14. The system of claim 12, wherein at least one of:
the application identifier corresponds to a version of the application, or
the application identifier is provisioned by a developer of the application, the authenticated developer identifier corresponding to the developer.

15. The system of claim 12, wherein the analytics collector is enabled to:
collect an analytic data point corresponding to an execution of the application by an authenticated user, the authenticated user having an authenticated user identifier, the authenticated user identifier authenticated by at least one of the plurality of services of the distributed computing services infrastructure; and
associate the application identifier and the authenticated user identifier with the analytic data point;
and wherein the analytics data storage entity is enabled to store the analytic data point and the association of the analytic data point with the application identifier and the authenticated user identifier.

16. The system of claim 12, wherein the analytics collector is enabled to:
collect an analytic data point corresponding to an execution of the application by an authenticated user on a device,
the authenticated user having an authenticated user identifier,
the authenticated user identifier authenticated by at least one of the plurality of services of the distributed computing services infrastructure,
the device having a device identifier, and
the device identifier is associated with the authenticated user identifier per an instruction from the authenticated user; and
associate the application identifier, the authenticated user identifier, and the device identifier with the analytic data point
and wherein the analytics data storage entity is enabled to store the analytic data point and the association of the analytic data point with the application identifier, the authenticated user identifier, and the device identifier.

17. The system of claim 12, wherein the plurality of services further includes at least one of an operating system service or an advertising service.

18. The system of claim 12, further comprising a report generator enabled to generate a unified analytics report for the application, the unified analytics report based on more than one analytic data point, wherein at least two of the more than one analytic data point are each collected from at least two different services of the plurality of services.

19. The system of claim 12, further comprising a billing entity enabled to bill a billable party based on the application identifier, the billable party associated with the authenticated developer identifier and selected from a group of billable party types including: a developer of the application, an organization having legal ownership of the application, and a work group of the organization.

20. A method of providing unified analytics, comprising:
provisioning an application identifier for an application developed to execute on a cloud computing infrastructure, the cloud computing infrastructure comprising a plurality of computing services distributed across a plurality of computing entities, the plurality of computing services including: an operating system service, storage service, a consumer service, an enterprise service, and optionally an advertising service;
collecting an analytic data point at each of the plurality of computing services corresponding to an execution of the application, the analytic data point corresponding to the execution of the application;
associating, with the analytic data point, the application identifier and one of:
an authenticated user identifier, or
the authenticated user identifier and a device identifier,
wherein the authenticated user identifier corresponds to an authenticated user of the cloud computing infrastructure, the authenticated user identifier authenticated by at least one of the plurality of computing services and corresponding to the execution the application, and
wherein the device identifier corresponds to a device defined by the authenticated user as being associated with the authenticated user identifier, the device corresponding to the execution of the application;
storing the analytic data point;
providing an access mechanism for the analytic data point, wherein:
the access mechanism allows access to the analytic data point based on the application identifier and an authenticated developer identifier,
the authenticated developer identifier is authenticated by at least one of the plurality of computing services, and
the authenticated developer identifier is associated with a billable party selected from a group of identifier types comprising: a developer of the application, an organization having legal ownership of the application, or a work group of the organization; and
generating a unified analytics report for the application based on more than one analytic data point, wherein at least two of the more than one analytic data point are each collected from different computing services from the plurality of computing services.
